(19) United States
(12) Patent Application Publication
(10) Pub. No.: US 2016/0085404 A1
(43) Pub. Date: Mar. 24, 2016

(54) Mobile Application Configuration

(71) Applicant: Alibaba Group Holding Limited, Grand Cayman (KY)

(72) Inventors: Bo Chen, Hangzhou (CN); Liang Zhou, Hangzhou (CN)

(21) Appl. No.: 14/858,682

(22) Filed: Sep. 18, 2015

(30) Foreign Application Priority Data
Sep. 19, 2014 (CN) 201410484369.4

(51) Int. Cl. G06F 3/0486; G06F 3/0481; G06F 17/30; G06F 3/0484

(52) U.S. Cl. CPC G06F 3/0486; G06F 3/04842; G06F 3/04817; G06F 17/30389

(57) ABSTRACT

The present disclosure provides techniques to application configuration. The method includes detecting, by a computing device, a trigger operation of a user on an icon of an application installed on a mobile terminal. If the trigger operation satisfies a predetermined condition, the computing device may provide a configuration interface. The configuration interface may include multiple functional areas, and an individual functional area of the multiple functional areas may correspond to an operation. In response to a determination that the icon is dragged to a functional area of the plurality functional areas, the computing device may perform a configuration on the application based on the operation corresponding to the functional area. According, the user may configure the application in the configuration interface. This expedites the operation of the application, therefore saving time and effort of the user and improving user experience.

### CROSS REFERENCE TO RELATED PATENT APPLICATIONS

This application claims priority to Chinese Patent Application No. 201410484369.4, filed on Sep. 19, 2014, entitled “Methods, Devices and Mobile Terminals for Application Configuration,” which is hereby incorporated by reference in its entirety.

### TECHNICAL FIELD

The present disclosure relates to mobile terminal device technology, and more particular, to methods, systems, and mobile terminals for application configuration.

### BACKGROUND

Existing methods for application icon operations on mobile devices generally include two types. For example, IOS® is developed by Apple® as a mobile operating system. After a user performs a long press operation on an icon of an application on a mobile device, the icon appears in a shaking situation at a top left corner of the screen of the mobile device and shows a delete button (See 102 in FIG. 1). The user may delete the application by selecting the delete button. In addition, dragging the application icon may sort the application icon. With respect to the Android® operating system, when a user deletes an application, the user has to drag the icon to a specified area (e.g., a garbage bin shown in the screen) (See 104 in FIG. 1). Accordingly, under current techniques, only deletion and/or sorting functions can be operated in a direct way. For other functions, the user may have to open the application or enter into an application market to operate these functions. This wastes time and energy of users, resulting in deterioration of the user experience.

### SUMMARY

A purpose of this disclosure is to solve at least one of the above-mentioned technical problems to some extent. Implementations herein relate to methods for application configuration. The methods may expedite user-friendly operations of an application more quickly, therefore saving a user's time and effort and improving user experience. This Summary is not intended to identify all key features or essential features of the claimed subject matter, nor is it intended to be used alone as an aid in determining the scope of the claimed subject matter.

The implementations here further relate to systems/devices for application configuration as well as to mobile terminals for application configuration. A method for application configuration may include, detecting, by a computing device, a trigger operation of a user on an icon of an application installed on a mobile terminal (e.g., a mobile phone). The computing device may provide a configuration interface if the trigger operation satisfies a predetermined condition. The configuration interface may include multiple functional areas, and an individual functional area of the multiple functional areas may correspond to an operation. The computing device may further detect a drag operation of a user on the icon in the configuration interface. In response to a determination that the icon is dragged to a functional area of the plurality functional areas, the computing device may perform a configuration on the application based on the operation corresponding to the functional area.

In implementations, the method for application configuration may detect a trigger operation of a user on an icon of an application installed on a mobile terminal. If the trigger operation satisfies a predetermined condition, the computing device may provide a configuration interface. In these instances, the configuration interface may include multiple functional areas, and an individual functional area of the multiple functional areas may correspond to an operation. In response to a determination that the icon is dragged to a functional area of the plurality of functional areas, the computing device may perform a configuration on the application based on the operation corresponding to the functional area. In other words, the user may be provided with the configuration interface and add customized functions (e.g., deleting, searching, sharing, etc.) in the configuration interface. The user may configure the application in the configuration interface. This expedites the operation of the application, therefore saving time and effort of the user and improving user experience.

A system/device for application configuration may include a first detecting module, a rendering module, a second detecting module, and/or a configuration module. The first detecting module may be configured to detect a trigger operation of a user on an icon of an application installed on a mobile terminal. The rendering module may be configured to provide a configuration interface if the trigger operation satisfies a predetermined condition. The configuration interface may include multiple functional areas, and an individual functional area of the multiple functional areas may correspond to an operation. The second detecting module may be configured to detect a drag operation of the user on the icon in the configuration interface. The configuration module configured to perform a configuration on the application based on the operation corresponding to the functional area in response to a determination that the icon is dragged to a functional area of the plurality functional areas.

In implementations, the system may detect, via the first detecting module, a trigger operation of a user on an icon of an application installed on a mobile terminal. The rendering module may provide a configuration interface if the trigger operation satisfies a predetermined condition. The configuration interface may include multiple functional areas, and an individual functional area of the multiple functional areas corresponding to an operation. The rendering module may perform a configuration on the application based on the operation corresponding to the functional area in response to a determination that the icon is dragged to a functional area of the plurality functional areas. In other words, the rendering module may add customized functions (e.g., deleting, searching, sharing, etc.) for the user in the configuration interface. The user may configure the application in the configuration interface. This expedites the operation of the application, therefore saving time and effort of the user and improving user experience.

In implementations, the mobile terminal may include the device for application configuration, as described above. The mobile terminal may, via the first detecting module of the device, detect a trigger operation of a user on an icon of an application installed on a mobile terminal. The rendering module may provide a configuration interface if the trigger operation satisfies a predetermined condition. The configuration interface may include multiple functional areas, and an individual functional area of the multiple functional areas may correspond to an operation.

The rendering module may perform a configuration on the application based on the operation corresponding to the functional area in response to a determination that the icon is dragged to a functional area of the plurality of functional areas. In other words, the rendering module may add customized functions (e.g., deleting, searching, sharing, etc.) for the user in the configuration interface. The user may configure the application in the configuration interface. This expedites the operation of the application, therefore saving time and effort of the user and improving user experience.

The mobile terminal may include a display and a processor. The processor may be configured to display an icon of an application, and the icon may be displayed with respect to a detailed operational interface of an operation corresponding to the icon in a user interface in response to a first operation of a user. The icon may be further displayed with respect to a quick search option around the icon in response to a second operation of the user. The icon may be further displayed with respect to an additional application having one or more functions that are similar to the application in response to a third operation of the user on the quick search option. At least two of the first operation, the second operation and the third operation are different.

The processor may be configured to display an icon of an application. The icon may be displayed in response to various operations performed by the user and make the appropriate processing operations in accordance with the various operations. In other words, the rendering module may add customized functions (e.g., deleting, searching, sharing, etc.) for the user in the configuration interface. The user may configure the application in the configuration interface. This expedites the operation of the application, therefore saving time and effort of the user and improving user experience.

### BRIEF DESCRIPTION OF THE DRAWINGS

The Detailed Description is described with reference to the accompanying figures. The use of the same reference numbers in different figures indicates similar or identical items.

FIG. 1 is a diagram of an interface illustrating application icon operations.

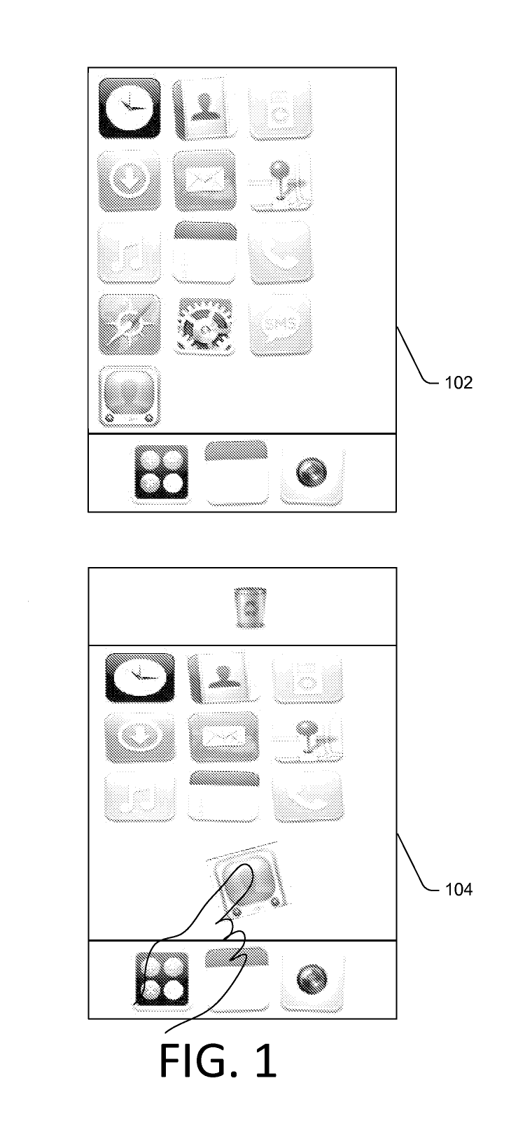

FIG. 2 is a flow chart of an illustrative process for application configuration.

FIG. 3 is a diagram of an interface illustrating application icon operations in accordance with implementations herein.

FIG. 4 is another diagram of an interface illustrating application icon operations in accordance with implementations herein.

FIG. 5 is a schematic diagrams of an illustrative computing architecture that enables application configuration.

FIG. 6 is another schematic diagrams of an illustrative mobile terminal that enables application configuration.

### DETAILED DESCRIPTION

Examples of the following detailed description of the present disclosure may be illustrated in the accompanying drawings. Throughout the same or similar reference numerals represent the same or similar elements or elements having the same or similar functions. The following examples with reference to the accompanying drawings are illustrative and are intended to explain the present application, and are not to be construed as limiting the present disclosure. It is described below with reference to the accompanying drawings configuration example of an application, and the mobile terminal apparatus according to the embodiment of the present application.

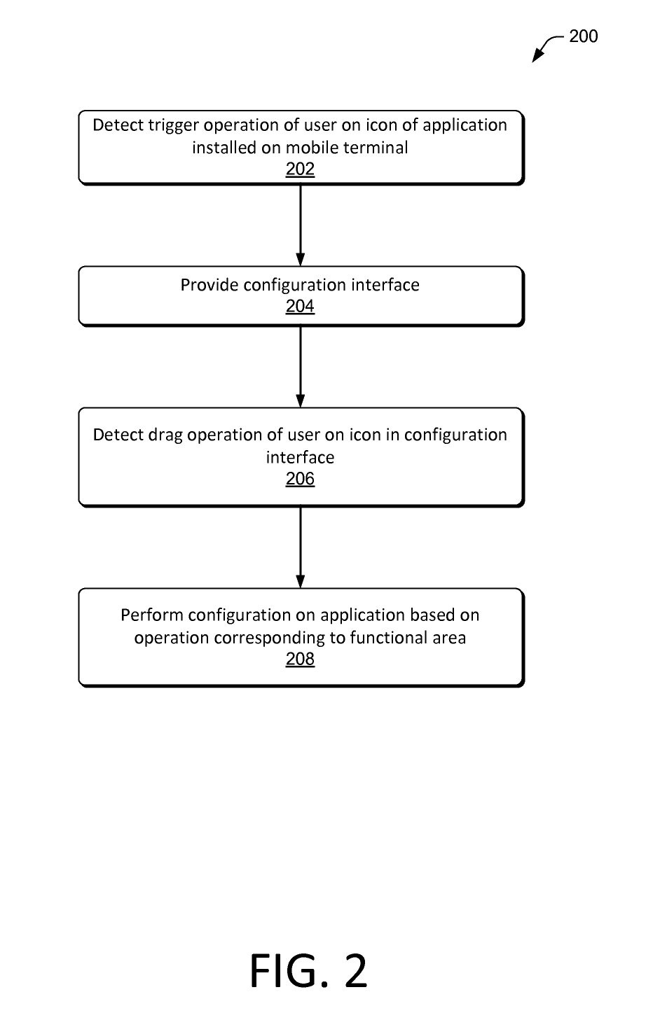

FIG. 2 is a flow chart of an illustrative process 200 for application configuration. At 202, a computing device may detect a trigger operation of a user on an icon of an application installed on a mobile terminal (e.g., the computing device). In implementations, the computing device may obtain information of applications installed on the mobile terminal. The computing device may detect a trigger operation of a user on an icon of an application installed on a mobile terminal. For example, the trigger operation may include a long press operation.

At 204, the computing device may provide a configuration interface if the trigger operation satisfies a predetermined condition. The configuration interface may include multiple functional areas, and an individual functional area of the multiple functional areas may correspond to an operation. In implementations, the multiple functional areas comprise at least two of a search functional area, a share functional area, or a remove functional area.

The individual functional area may include an icon indicating the operation corresponding to the individual functional area. For example, when the trigger operation is the long press operation, a time period of the long press operation is greater than a predetermined value.

The predetermined time period may be, for example, one second. Suppose that the mobile terminal installs an application “Youdao,” which is a dictionary application. The computing device may detect a trigger operation of a user on an icon of Youdao. If the trigger operation is a long press operation, and the long press operation on “Youdao” is greater than a predetermined time period (e.g., 1 second) and the user has been holding down the icon, the computing device may display a configuration interface in the display screen of the mobile terminal.

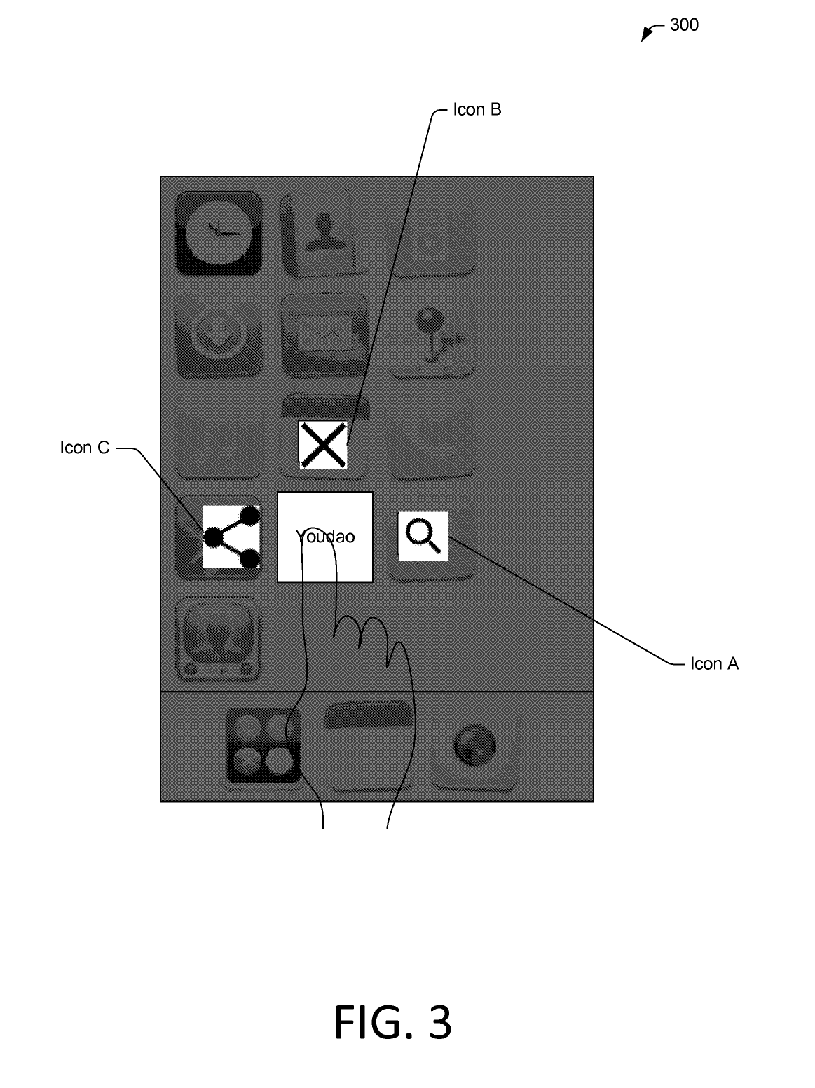

FIG. 3 is a diagram of an interface 300 illustrating application icon operations in accordance with implementations herein. As illustrated in FIG. 3, the configuration interface may include various functional areas such as a share functional area, a remove functional area, and a search function functional area. These functional areas may be placed around the icon of “Youdao”. Further, the computing device may display the search functional area via icon A. Icon B may display the remove functional area, and icon C may display the share functional area.

At 206, the computing device may detect a drag operation of the user on the icon in the configuration interface. In implementations, a drag operation may indicate that a user presses an icon of an application and drags the icon on the display of the mobile terminal. On the other hand, after providing the configuration interface, the computing device may detect whether the user performs a drag operation on the icon in the configuration interface. Further, the computing device may perform real-time detection of the movement trajectory when the user drags the icon. For example, the computing device may detect that the icon is dragged to a functional area.

At 208, in response to a determination that the icon is dragged to a functional area of the plurality functional areas, the computing device may perform a configuration on the application based on the operation corresponding to the functional area.

In implementations, in response to the determination that the icon is dragged to a functional area, the computing device may call a system program or a third party application corresponding to the functional area. Further, the computing device may perform the configuration on the application using the system program or the third party application. For different operations corresponding to different functional areas, there may be different configurations.

In implementations, in response to the determination that the icon is dragged to a search functional area of the plurality functional areas, the computing device may perform a configuration on the application based on the operation corresponding to the functional area. In implementations, the computing device may call a third party application corresponding to a searching function to use the third party application to search applications that are similar to the installed application and obtain a search result of the application.

The computing device may further display the search result on the configuration interface. Again, suppose that the mobile terminal installs an application: Youdao. In response to the determination that the icon is dragged to a search functional area, the computing device may call an installed third party application having a search function. The third party application may perform searches based on Youdao's icon and/or title to obtain search results related to Youdao. For example, the results may include Youdao Translator or Youdao Traveling Translator.

The computing device may further display the search result on the configuration interface.

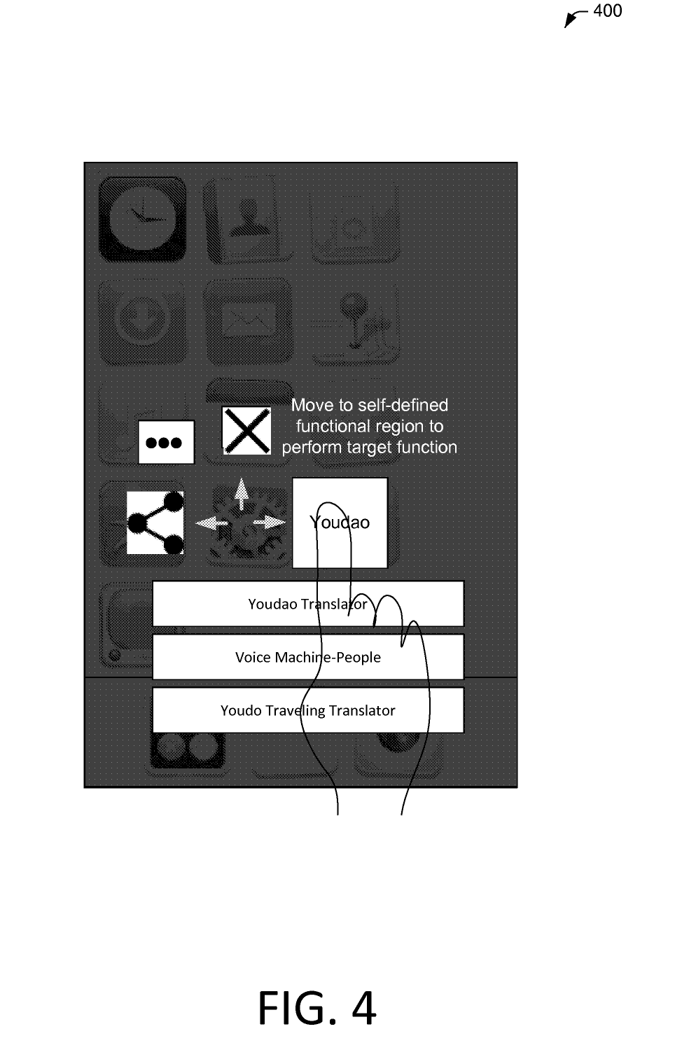

FIG. 4 is another diagram of an interface 400 illustrating application icon operations in accordance with implementations herein. The search results may be displayed in multiple web-pages. The user may scroll up and down to view the multiple web-pages. Accordingly, the computing device may perform search functions when the icon is dragged in the configuration interface.

In implementations, in response to the determination that the icon is dragged to a search functional area, the computing device may perform a configuration on the application based on the operation corresponding to the functional area. The computing device may call a third party application corresponding to a sharing function to perform sharing on the application using the third party application.

Suppose that the mobile terminal installs an application: Youdao. The computing device may detect that the icon is dragged to the sharing functional area. The computing device may call a third party application corresponding to a sharing function, such as Tencent QQ application, the wechat application, Sina microblogging application, etc. The computing device may perform sharing on the application using these third party applications. Accordingly, if the user wants to share an application, the user may find the sharing functional area to call the third party application to share the application without running the application. This greatly eliminates the need for cumbersome user operations, and therefore improves user experience.

In implementations, in response to the determination that the icon is dragged to a remove functional area, the computing device may perform a configuration on the application based on the operation corresponding to the functional area. The computing device may call a third party application corresponding to a remove function to remove the application using the third party application or the system application. Suppose that the mobile terminal installs an application: Youdao. The computing device may detect that the icon is dragged to the remove functional area. The computing device may remove (e.g., uninstall) the application using the third party application or the system application. The system application may include an application manager. The third party application may include a software manager.

The computing device may remove the application using these third party applications and enter into a normal procedure for removal. This facilitates users to remove applications from their mobile terminals.

The method for application configuration may detect a trigger operation of a user on an icon of an application installed on a mobile terminal. The computing device may provide a configuration interface if the trigger operation satisfies a predetermined condition. In these instances, the configuration interface may include multiple functional areas, and an individual functional area of the multiple functional areas may correspond to an operation. In response to a determination that the icon is dragged to a functional area of the plurality functional areas, the computing device may perform a configuration on the application based on the operation corresponding to the functional area. In other words, the rendering module may add customized functions (e.g., deleting, searching, sharing, etc.) for the user in the configuration interface.

The user may configure the application in the configuration interface. This expedites the operation of the application, therefore saving time and effort of the user and improving user experience.

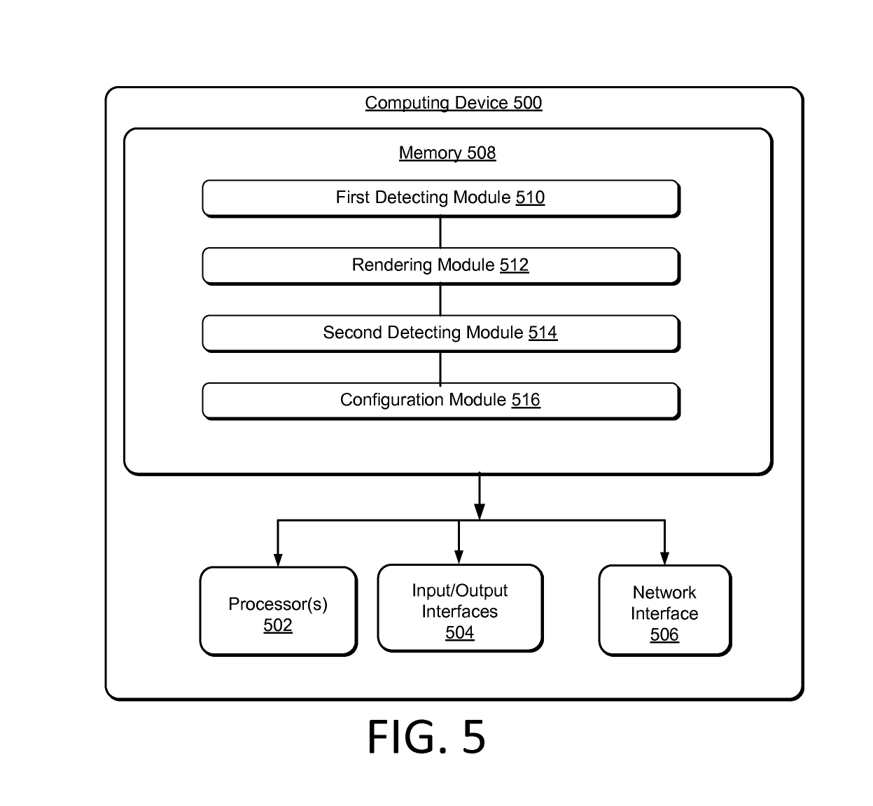

FIG. 5 is a schematic diagram of an illustrative computing architecture that enables application configuration. FIG. 5 includes a diagram of a computing device 500. The computing device 500 may be a user device or a server for application configuration. In one exemplary configuration, the computing device 500 includes one or more processors 502, input/output interfaces 504, network interface 506, and memory 508.

The memory 508 may include computer-readable media in the form of volatile memory, such as random-access memory (RAM) and/or non-volatile memory, such as read only memory (ROM) or flash RAM. The memory 508 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 508 in more detail, the memory 508 may include a first detecting module 510, a rendering module 512, a second detecting module 514, and/or a configuration module 516.

The first detecting module 510 may be configured to detect a trigger operation of a user on an icon of an application installed on a mobile terminal. For example, the first detecting module may be configured to obtain information of applications installed on the mobile terminal.

The computing device may detect a trigger operation of a user on an icon of an application installed on a mobile terminal. For example, the trigger operation may include a long press operation.

The rendering module 512 may be configured to provide a configuration interface if the trigger operation satisfies a predetermined condition. The configuration interface may include multiple functional areas, and an individual functional area of the multiple functional areas may correspond to an operation. In some implementations, the multiple functional areas comprise at least two of a search functional area, a share functional area, or a remove functional area. The individual functional area may include an icon indicating the operation corresponding to the individual functional area.

In implementations, if the trigger operation is a long press operation, the predetermination condition is a time period of the long press operation is greater than a predetermined value. The predetermined time may be, for example, one second.

Suppose that the mobile terminal installs an application: Youdao. The computing device may detect a trigger operation of a user on an icon of Youdao. If the long press operation on “Youdao” is greater than a predetermined time period (e.g., 1 second) and the user has been holding down the icon. The rendering module may be configured to display a configuration interface in the display of the mobile terminal.

As illustrated in FIG. 3, the configuration interface may include various functional areas such as a share functional area, a remove functional area, and a search function functional area. These functional areas may be placed around the icon of “Youdao”. Further, the computing device may display the search functional area via icon A. Further, the computing device may display the remove functional area via icon B. Further, the computing device may display the share functional area via icon C. The second detecting module 514 may be configured to detect a drag operation of the user on the icon in the configuration interface.

In implementations, a drag operation may indicate that a user press an icon of an application and drag the icon on the display of the mobile terminal. After providing the configuration interface, the second detecting module 514 may detect whether the user perform a drag operation on the icon in the configuration interface. Further, the computing device may perform real-time detection of the movement trajectory when the user drags the icon. For example, the computing device may detect that the icon is dragged to a functional area.

The configuration module 516 may be configured to perform a configuration on the application based on the operation corresponding to the functional area in response to a determination that the icon is dragged to a functional area of the plurality functional areas.

In implementations, in response to the determination that the icon is dragged to a functional area, the configuration module 516 may call a system program or a third party application corresponding to the functional area. Further, the computing device may perform the configuration on the application using the system program or the third application. For different operations corresponding to different functional areas, there may be different configurations.

In implementations, in response to the determination that the icon is dragged to a search functional area of the plurality functional areas, the configuration module 516 may be configured to call a third party application corresponding to a searching function to perform searches on the application using the third party application and to obtain a search result of the application. The computing device may further display the search result on the configuration interface.

Suppose that the mobile terminal installs an application: Youdao. The computing device may detect that the icon is dragged to the removing functional area. The configuration module 516 may call a third party application corresponding to a sharing function. The third party application may perform searches based on Youdao's icon and/or title to obtain search results related to Youdao and obtain a search result of the application. For example, the results may include Youdao Translator or Youdao Traveling Translator. The computing device may further display the search result on the configuration interface.

As illustrated in FIG. 4, the search results may be displayed in multiple web-pages, and the user may scroll up and down to view the multiple web-pages. Accordingly, the computing device may perform search functions when the icon is dragged in the configuration interface.

In implementations, in response to the determination that the icon is dragged to a search functional area of the plurality functional areas, the configuration module 516 may call a third party application corresponding to a sharing function to perform sharing on the application using the third party application.

Suppose that the mobile terminal installs an application: Youdao. The computing device may detect that the icon is dragged to the sharing functional area. The configuration module 516 may call a third party application corresponding to a sharing function. Such as Tencent QQ client, the micro-channel client, Sina microblogging client, etc.

The computing device may perform sharing on the application using these third party applications. Accordingly, if the user wants to share an application, the user may find the sharing functional area to call the third party application to sharing the application without running the application. The computing device may call the third party application to sharing the application without running the application. This greatly eliminates the need for cumbersome user operations, and therefore improves convenience.

In implementations, in response to the determination that the icon is dragged to a remove functional area of the plurality functional areas, the configuration module 516 calls a third party application corresponding to a remove function to remove the application using the third party application or the system application. Suppose that the mobile terminal installs an application: Youdao. The computing device may detect that the icon is dragged to the removing functional area. The configuration module 516 may call a third party application corresponding to a remove function.

In implementations, the system application may include an application manager. The third party application may include a software manager. The computing device may remove the application using these third party applications and enter into a normal procedure for removal. The computing device may remove the application using these third party applications and enter into a normal procedure for removal. This facilitates users to remove applications from their mobile terminals.

The computing device may, via the first detecting module, determine that the trigger operation satisfies a predetermined condition, the rendering module 512 may provide a configuration interface. The configuration interface may include multiple functional areas, and an individual functional area of the multiple functional areas may correspond to an operation. In response to a determination that the icon is dragged to a functional area of the plurality functional areas, the rendering module 512 may perform a configuration on the application based on the operation corresponding to the functional area. In other words, the user may be provided with the configuration interface and add customized functions (e.g., deleting, searching, sharing, etc.) in the configuration interface. The user may configure the application in the configuration interface. This expedites the operation of the application, therefore saving time and effort of the user and improving user experience.

The implementations here further relate to systems/devices for application configuration on a mobile terminal. The system may include a first detecting module may determine that the trigger operation satisfies a predetermined condition, the rendering module may provide a configuration interface. The configuration interface may include multiple functional areas, and an individual functional area of the multiple functional areas may correspond to an operation. In response to a determination that the icon is dragged to a functional area of the plurality functional areas, the rendering module may perform a configuration on the application based on the operation corresponding to the functional area. In other words, the rendering module may add customized functions (e.g., deleting, searching, sharing, etc.) for the user in the configuration interface. The user may configure the application in the configuration interface. This expedites the operation of the application, therefore saving time and effort of the user and improving user experience.

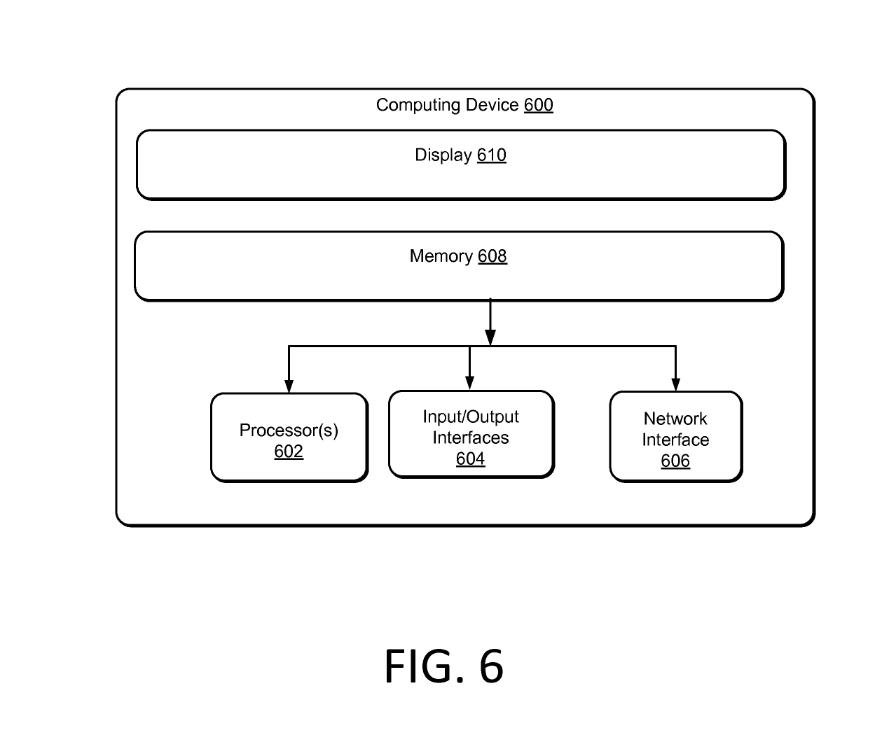

FIG. 6 is a schematic diagrams of an illustrative computing architecture that enables application configuration. FIG. 6 includes a diagram of a computing device 600. The computing device 600 may be a mobile terminal for application configuration. In one exemplary configuration, the computing device 600 includes one or more processors 602, input/output interfaces 604, network interface 606, and memory 608.

The memory 608 may include computer-readable media in the form of volatile memory, such as random-access memory (RAM) and/or non-volatile memory, such as read only memory (ROM) or flash RAM. The memory 608 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

The processor 602 may be configured to display an icon of an application in the display 610. In implementations, the icon may be further configured to display a detailed operational interface of an operation corresponding to the icon in a user interface in response to a first operation of a user. The icon may be further configured to display a quick search option around the icon in response to a second operation of the user. The icon may be further configured to display an additional application having one or more functions that are similar to the application in response to a third operation of the user on the quick search option.

At least two of the first operation, the second operation and the third operation are different. For example, the second operation is a long press operation, the second operation is a long press operation, and the third operation is a drag operation. Suppose that the mobile terminal installs an application: Youdao. The computing device may detect a trigger operation of a user on an icon of Youdao. In response to a first operation of a user, displaying a detailed operational interface of an operation corresponding to the icon in a user interface. Suppose that the mobile terminal installs an application: Youdao. The computing device may detect a trigger operation of a user on an icon of Youdao (e.g., a long press operation longer than 2 seconds). The computing device may display a quick search option around the icon as shown in FIG. 3. In response to the determination that the icon of Youdao is dragged to a functional area, the computing device may display an application having a function similar to Youdao on the display 610, as shown in FIG. 4.

In implementations, the processor may be configured to display an icon of an application. The icon may be further configured to respond to various operations performed by the user and make the appropriate processing operations in accordance with the various operations. In other words, the rendering module may add customized functions (e.g., deleting, searching, sharing, etc.) for the user in the configuration interface. The user may configure the application in the configuration interface. This expedites the operation of the application, therefore saving time and effort of the user and improving user experience.

It should be understood that the mobile terminal may include cell phones, tablet computers, personal digital assistant with a variety of operating systems and other hardware devices. In the description of the present application, it is understood that the terms “first”, “second” are merely for the purpose of description and should not indicate or imply relative importance or numbers of technical features. Thus, there is defined “first”, “second” features may explicitly or implicitly includes at least one of the feature. In the description of the present application, “plurality” means at least two. In the description of the present specification, reference to the term “one embodiment,” “some embodiments”, “an example”, “concrete example”, or “some examples” and the other descriptions refer to a particular feature of the embodiments or examples described , structure, material, or characteristic included in the present application is at least one embodiment or example. In the present specification, the term of the above schematic representation is not necessarily for the same embodiment or example. Furthermore, the particular features, structures, materials, or characteristics described in any one or more of the exemplary embodiment in a suitable manner or in combination.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method comprising:
detecting a trigger operation of a user on an icon of an application installed on a mobile terminal;
providing a configuration interface if the trigger operation satisfies a predetermined condition, the configuration interface comprising a plurality of functional areas, an individual functional area of the plurality of functional areas corresponding to an operation associated with the application;
detecting a drag operation of the user on the icon in the configuration interface; and
performing a configuration on the application based on the operation corresponding to the functional area in response to a determination that the icon is dragged to a functional area of the plurality functional areas.

2. The method of claim 1, wherein the performing the configuration on the application based on the operation corresponding to the functional area comprises:
calling a system program or a third party application corresponding to the functional area; and
performing the configuration on the application using the system program or the third party application.

3. The method of claim 1, wherein the plurality of functional areas include at least two of a search functional area, a share functional area, or a remove functional area.

4. The method of claim 3, wherein the individual functional area includes an icon indicating the operation corresponding to the individual functional area.

5. The method of claim 1, wherein the performing the configuration on the application based on the operation corresponding to the functional area in response to the determination that the icon is dragged to the functional area of the plurality functional areas comprises:
calling a third party application corresponding to a searching function to use the third party application to search applications that are similar to the installed application in response to the determination that the icon is dragged to a search functional area of the plurality functional areas;
obtaining a search result of the application; and
displaying the search result on the configuration interface.

6. The method of claim 1, wherein the performing the configuration on the application based on the operation corresponding to the functional area in response to the determination that the icon is dragged to the functional area of the plurality functional areas comprises:
calling a third party application corresponding to a sharing function to perform a sharing operation on the application using the third party application in response to the determination that the icon is dragged to a share functional area of the plurality functional areas.

7. The method of claim 1, wherein the performing the configuration on the application based on the operation corresponding to the functional area in response to the determination that the icon is dragged to the functional area of the plurality functional areas comprises:
calling a third party application corresponding to a remove function to remove the application using a third party application or a system application in response to the determination that the icon is dragged to a remove functional area of the plurality functional areas.

8. The method of claim 1, wherein the predetermined condition is a time period of a long press operation that is greater than a predetermined value if the trigger operation is a long press operation.

9. A system comprising:
one or more processors; and
memory to maintain a plurality of components executable by the one or more processors, the plurality of components comprising:
a first detecting module configured to detect a trigger operation of a user on an icon of an application installed on a mobile terminal,
a rendering module configured to provide a configuration interface if the trigger operation satisfies a predetermined condition, the configuration interface comprising a plurality of functional areas, an individual functional area of the plurality of functional areas corresponding to an operation,
a second detecting module configured to detect a drag operation of the user on the icon in the configuration interface, and
a configuration module configured to perform a configuration on the application based on the operation corresponding to the functional area in response to a determination that the icon is dragged to a functional area of the plurality functional areas.

10. The system of claim 9, wherein the configuration module is further configured to:
call a system program or a third party application associated with the mobile terminal corresponding to the functional area; and
perform the configuration on the application using the system program or the third party application.

11. The system of claim 10, wherein the plurality of functional areas comprise at least two of a search functional area, a share functional area, or a remove functional area.

12. The system of claim 11, wherein the individual functional area comprises an icon indicating the operation corresponding to the individual functional area.

13. The system of claim 9, wherein the configuration module is further configured to:
call the third party application associated with the mobile terminal corresponding to a searching function to use the third party application to search applications that are similar to the installed application in response to the determination that the icon is dragged to a search functional area of the plurality functional areas;
obtain a search result of the application; and
display the search result on the configuration interface.

14. The system of claim 9, wherein the configuration module is configured to call a third party application corresponding to a sharing function to perform a sharing operation on the application using the third party application in response to the determination that the icon is dragged to a sharing functional area of the plurality functional areas.

15. The system of claim 9, wherein the configuration module is configured to call a third party application corresponding to a remove function to removing the application using the third party application or a system application in response to the determination that the icon is dragged to a remove functional area of the plurality functional areas.

16. The system of claim 9, wherein the predetermination condition is a time period of a long press operation that is greater than a predetermined value if the trigger operation is a long press operation.

17. A mobile terminal comprising:
a display;
one or more processors; and
memory to maintain a plurality of components executable by the one or more processors, the one or more processor configured to:
display an icon of an application;
display a detailed operational interface of an operation corresponding to the icon in a user interface in response to a first operation of a user;
display a quick search option around the icon in response to a second operation of the user;
display search results comprising one or more applications having one or more functions that are similar to the application in response to a third operation of the user on the quick search option, wherein at least two of the first operation, the second operation and the third operation are different.

18. The mobile terminal of claim 18, wherein the first operation is a short press operation, the second operation is a long press operation, and the third operation is a drag operation.

19. The mobile terminal of claim 18, wherein the second operation and the third operation and performed continuously.

20. The mobile terminal of claim 19, wherein a time period of the long press operation is greater than a predetermined value.
